(19) United States
(12) Patent Application Publication
(10) Pub. No.: US 2026/0279282 A1
(43) Pub. Date: Sep. 17, 2026

(54) DISPLAY DEVICE AND ELECTRONIC DEVICE

(71) Applicant: Samsung Display Co., Ltd., Yongin-si (KR)

(72) Inventors: Jin Seon KWAK, Yongin-si (KR); Kyung Bae KIM, Yongin-si (KR); Dong Woo KIM, Yongin-si (KR); Yun Jang PYUN, Yongin-si (KR)

(21) Appl. No.: 19/547,281

(22) Filed: Feb. 23, 2026

(30) Foreign Application Priority Data
Mar. 12, 2025 (KR) 10-2025-0032183

(51) Int. Cl. G09G 3/3233; G09G 3/32

(52) U.S. Cl. CPC G09G 3/3233; G09G 3/32; G09G 2300/0819; G09G 2300/0852; G09G 2300/0861; G09G 2310/08; G09G 2320/0233

(57) ABSTRACT

A display device includes: a light-emitting element connected between a first supply voltage line and a second supply voltage line; a first transistor connected between the light-emitting element and the second supply voltage line, and comprising a gate electrode connected to a first node and a source electrode connected to a second node; a second transistor connected between a data line and a third node; a third transistor connected between the first node and a third supply voltage line; a fourth transistor connected between the third node and the second node; a first capacitor connected between the first node and the third node; and a second capacitor connected between the third node and a first electrode of the light-emitting element.

### CROSS-REFERENCE TO RELATED APPLICATION

The present application claims priority to and the benefit of Korean Patent Application No. 10-2025-0032183, filed on Mar. 12, 2025, in the Korean Intellectual Property Office, the entire disclosure of which is incorporated herein by reference.

### BACKGROUND

### 1. Field

Aspects of some embodiments of the present disclosure relate to a display device.

### 2. Description of the Related Art

An organic light-emitting diode display, unlike a liquid-crystal display, is self-luminous. Accordingly, an organic light-emitting diode display generally does not require a separate light source and thus it can be made relatively lighter and thinner. In addition, an organic light-emitting diode display has high-quality characteristics such as relatively low power consumption, high luminance and fast response speed, and thus is attracting attention as the next generation display.

The above information disclosed in this Background section is only for enhancement of understanding of the background and therefore the information discussed in this Background section does not necessarily constitute prior art.

### SUMMARY

Aspects of some embodiments of the present disclosure relate to a display device, and for example, to a display device with relatively improved image quality, and an electronic device.

Aspects of some embodiments of the present disclosure provide a display device with relatively improved image quality, and an electronic device.

According to some embodiments of the present disclosure, a display device includes: a light-emitting element connected between a first supply voltage line and a second supply voltage line; a first transistor connected between the light-emitting element and the second supply voltage line, and comprising a gate electrode connected to a first node and a source electrode connected to a second node; a second transistor connected between a data line and a third node; a third transistor connected between the first node and a third supply voltage line; a fourth transistor connected between the third node and the second node; a first capacitor connected between the first node and the third node; and a second capacitor connected between the third node and a first electrode of the light-emitting element.

According to some embodiments of the present disclosure, an electronic device includes a display device that includes a display screen. According to some embodiments, the display device includes: a light-emitting element connected between a first supply voltage line and a second supply voltage line; a first transistor connected between the light-emitting element and the second supply voltage line, and comprising a gate electrode connected to a first node and a source electrode connected to a second node; a second transistor connected between a data line and a third node; a third transistor connected between the first node and a third supply voltage line; a fourth transistor connected between the third node and the second node; a first capacitor connected between the first node and the third node; and a second capacitor connected between the third node and a first electrode of the light-emitting element.

According to some embodiments of the present disclosure, the image quality of a display device and an electronic device may be relatively improved. For example, one side of a second capacitor may be connected to an anode electrode of a light-emitting element (e.g., a fourth node). Accordingly, the voltage of the anode electrode may be compensated through the first capacitor and the second capacitor. Accordingly, the voltage fluctuation rate of the anode electrode can be relatively reduced, and thus the luminance deviations of the light-emitting element in adjacent emission periods having a large grayscale difference can be relatively reduced. Therefore, the image quality of the display device can be relatively improved.

In addition, according to some embodiments of the present disclosure, during a data write period, the fourth node is initialized to a first supply voltage provided through a turned-on fifth transistor, so that the influence according to the degree of deterioration of an emissive layer of a light-emitting element can be eliminated during a process of compensating the threshold voltage in that data write period. Therefore, the threshold voltage of the first transistor can be relatively accurately compensated regardless of the degree of deterioration of the emissive layer in the data write period.

In addition, according to some embodiments of the present disclosure, each of the transistors of a sub-pixel may be an n-type metal-oxide-semiconductor field effect transistor (MOSFET). Accordingly, the degree of integration of the transistors can be relatively improved.

The characteristics of embodiments of the present disclosure are not limited to the above-described characteristics and other characteristics which are not described herein will become more apparent to those skilled in the art from the following description.

### BRIEF DESCRIPTION OF THE DRAWINGS

The above and other aspects and features of embodiments according to the present disclosure will become more apparent by describing in more detail aspects of some embodiments thereof with reference to the attached drawings, in which:

FIG. 1 is an exploded, perspective view of a display device according to some embodiments of the present disclosure.

FIG. 2 is a block diagram showing a display device according to some embodiments of the present disclosure.

FIG. 3 is an equivalent circuit diagram of a first sub-pixel according to some embodiments of the present disclosure.

FIG. 4 is a timing diagram of an initialization scan signal, a write scan signal, a bias scan signal, a first emission control signal, a second emission control signal and a data signal of FIG. 3.

FIG. 5 is a diagram for illustrating an operation of the display device of FIG. 3 in an initialization period of FIG. 4.

FIG. 6 is a diagram for illustrating an operation of the display device of FIG. 3 in a threshold voltage detection period of FIG. 4.

FIG. 7 is a diagram for illustrating an operation of the display device of FIG. 3 in a data write period of FIG. 4.

FIG. 8 is a diagram for illustrating an operation of the display device of FIG. 3 in an emission period of FIG. 4.

FIG. 9 is an equivalent circuit diagram of a first sub-pixel according to some embodiments of the present disclosure.

FIG. 10 is a timing diagram of an initialization scan signal, a write scan signal, a bias scan signal, a first emission control signal, a second emission control signal and a data signal of FIG. 9.

FIG. 11 is an equivalent circuit diagram of a first sub-pixel according to some embodiments of the present disclosure.

FIG. 12 is a timing diagram of an initialization scan signal, a write scan signal, a bias scan signal, a first emission control signal, a second emission control signal and a data signal of FIG. 11.

FIG. 13 is a block diagram of an electronic device according to some embodiments of the present disclosure.

FIGS. 14, 15 and 16 are views showing electronic devices according to some embodiments of the present disclosure.

### DETAILED DESCRIPTION

Aspects of some embodiments of the present disclosure will now be described more fully hereinafter with reference to the accompanying drawings, in which aspects of some embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

It will also be understood that when a layer is referred to as being “on” another layer or substrate, it can be directly on the other layer or substrate, or intervening layers may also be present. The same reference numbers indicate the same components throughout the specification. In the attached figures, the thickness of layers and regions is exaggerated for clarity.

Although the terms “first”, “second”, etc. may be used herein to describe various elements, these elements, should not be limited by these terms. These terms may be used to distinguish one element from another element. Thus, a first element discussed below may be termed a second element without departing from teachings of one or more embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

Features of various embodiments of the present disclosure may be combined partially or totally. As will be clearly appreciated by those skilled in the art, technically various interactions and operations are possible. Various embodiments can be practiced individually or in combination.

Hereinafter, aspects of some embodiments of the present disclosure will be described in more detail with reference to the accompanying drawings.

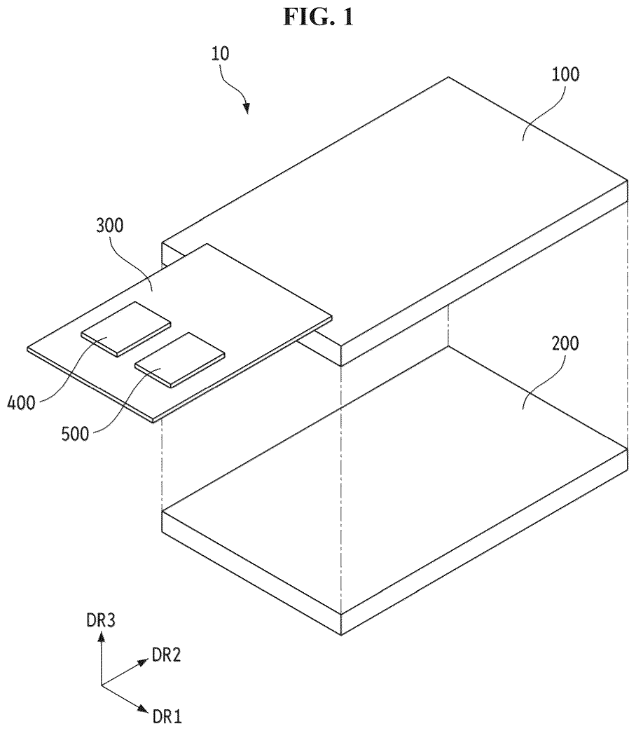

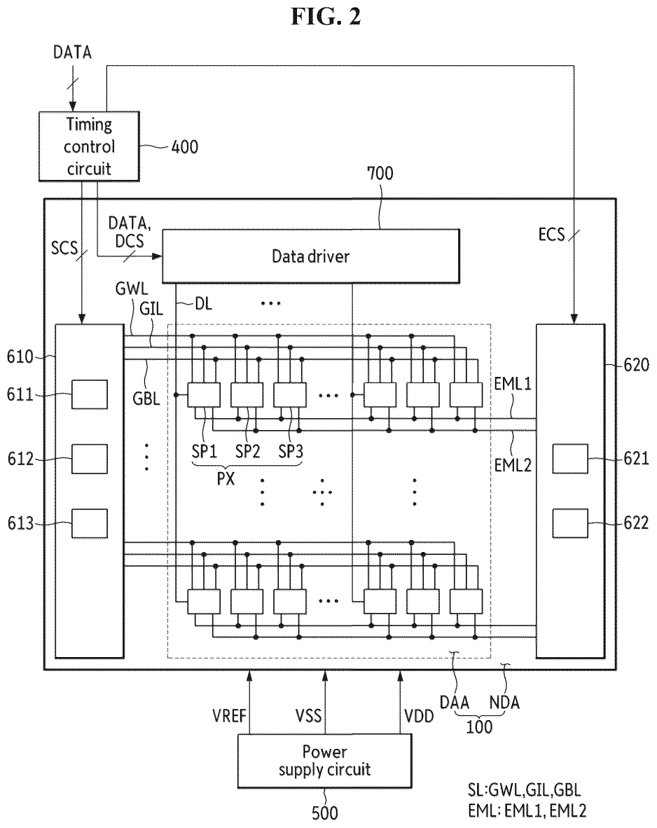

FIG. 1 is an exploded, perspective view of a display device according to some embodiments of the present disclosure. FIG. 2 is a block diagram showing a display device according to some embodiments of the present disclosure.

Referring to FIGS. 1 and 2, the display device 10 according to some embodiments displays moving images (e.g., video images) or still images (e.g., static images). The display device 10 according to some embodiments may be employed by portable electronic devices such as a mobile phone, a smart phone, a tablet PC, a mobile communications terminal, an electronic notebook, an electronic book, a portable multimedia player (PMP), a navigation device and a ultra mobile PC (UMPC). For example, the display device 10 according to some embodiments of the present disclosure may be used as a display unit of a television, a laptop computer, a monitor, an electronic billboard, or the Internet of Things (IOT). Alternatively, the display device 10 according to some embodiments of the present disclosure may be applied to a smart watch, a watch phone, or a head-mounted display (HMD) for implementing virtual reality and augmented reality.

According to some embodiments, the display device 10 includes a display panel 100, a heat dissipation layer 200, a circuit board 300, a timing control circuit 400, and a power supply circuit 500.

The display panel 100 may have a shape similarly to a rectangular shape when viewed from the top (e.g., in a plan view, or from a view perpendicular to a display surface of the display panel 100). For example, the display panel 100 may have a shape similar to a rectangle having shorter sides in the first direction DR1 and longer sides in the second direction DR2 intersecting the first direction DR1 when viewed from the top (e.g., in a plan view). In the display panel 100, the corners where the shorter sides in the first direction DR1 meet the longer sides in the second direction DR2 may be rounded with a curvature (e.g., a set or predetermined curvature) or may be a right angle. The shape of the display panel 100 when viewed from the top (e.g., in a plan view) is not limited to a rectangular shape, but may be formed in a shape similar to other polygonal shapes, a circular shape, an elliptical shape, or an irregular shape. The shape of the display device 10 may follow the shape of the display panel 100 when viewed from the top (e.g., in a plan view), but the embodiments of the present disclosure are not limited thereto.

The display panel 100 includes a plurality of pixels PX, a plurality of scan lines SL, a plurality of emission control lines EML, a plurality of data lines DL, a scan driver 610, an emission driver 620, and a data driver 800. The display panel 100 may be divided into a display area DAA where images are displayed, and a non-display area NDA where no images are displayed as shown in FIG. 2. According to some embodiments, the non-display area NDA may surround (e.g., in a periphery or outside a footprint of) the display area DAA.

The plurality of pixels PX may be arranged in the display area DAA. The pixels PX may be arranged in a matrix in the first direction DR1 and the second direction DR2. The scan lines SL and the emission control lines EML may extend in the first direction DR1 and may be arranged in the second direction DR2. The data lines DL may extend in the second direction DR2 and may be arranged in the first direction DR1.

The plurality of scan lines SL includes a plurality of write scan lines GWL, a plurality of initialization scan lines GIL, and a plurality of bias scan lines GBL. The plurality of emission control lines EML includes a plurality of first emission control lines EML1 and a plurality of second emission control lines EML2. Among the scan lines GIL, GWL and GBL, the initialization scan line GIL may be the (n−1)^{th} scan line, the write scan line GWL may be the nth scan line, and the bias scan line GBL may be the (n+1)^{th} scan line.

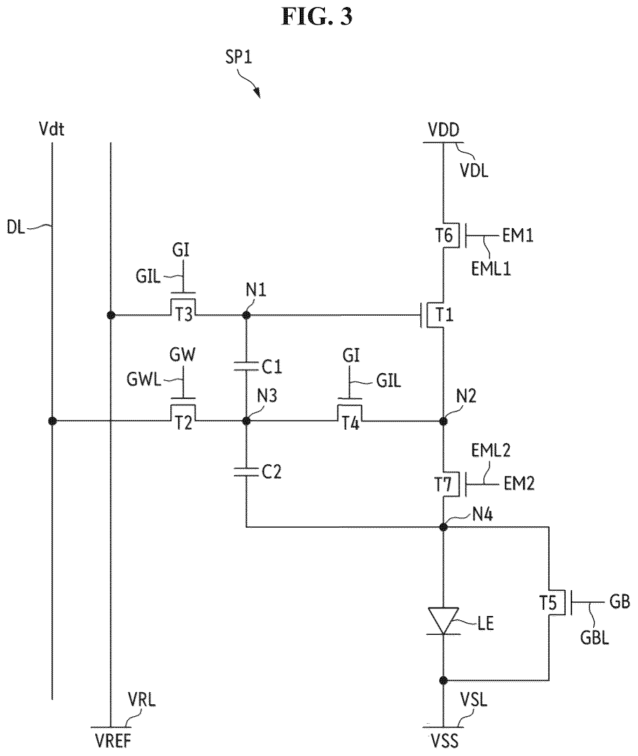

The plurality of pixels PX includes a plurality of sub-pixels SP1, SP2 and SP3. The plurality of sub-pixels SP1, SP2 and SP3 may include a plurality of pixel transistors as shown in FIG. 3. The pixel transistors may be formed via a semiconductor process and may be arranged on a semiconductor substrate. For example, the pixel transistors of a data driver 800 may be implemented as complementary metal oxide semiconductor (CMOS). It should be understood, however, that the embodiments of the present disclosure are not limited thereto.

Each of the sub-pixels SP1, SP2 and SP3 may be connected to one of the write scan lines GWL, one of the control scan lines GCL, one of the bias scan lines GBL, one of the initialization scan line GIL, one of the first emission control lines EM1, one of the second emission control lines EM2, and one of the data lines DL. Each of the sub-pixels SP1, SP2 and SP3 may receive the data voltage from the data line DL according to the write scan signal from the write scan line GWL, and may allow the light-emitting elements to emit light according to the data voltage.

The scan driver 610, the emission driver 620, and the data driver 800 may be located in the non-display area NDA.

The scan driver 610 includes a plurality of scan transistors, and the emission driver 620 includes a plurality of light-emitting transistors. A plurality of scan transistors and a plurality of light-emitting transistors may be formed via a semiconductor process and may be formed on the semiconductor substrate (e.g., a wafer). For example, a plurality of scan transistors and a plurality of light-emitting transistors may be implemented as CMOS transistors. It should be understood, however, that the embodiments of the present disclosure are not limited thereto.

The scan driver 610 may include a write scan signal output unit 611, an initialization scan signal output unit 612, and a bias scan signal output unit 613. Each of the write scan signal output unit 611, the initialization scan signal output unit 612 and the bias scan signal output unit 613 may receive a scan timing control signal SCS from the timing control circuit 400. The write scan signal output unit 611 may generate write scan signals according to the scan timing control signal SCS from the timing control circuit 400 and sequentially output them to the write scan lines GWL. The initialization scan signal output unit 612 may generate initialization scan signals according to the scan timing control signal SCS and sequentially output them to the initialization scan lines GIL. The bias scan signal output unit 613 may generate bias scan signals according to the scan timing control signal SCS and sequentially output them to the bias scan lines GBL.

The emission driver 620 includes a first emission control driver 621 and a second emission control driver 622. Each of the first emission control driver 621 and the second emission control driver 622 may receive an emission timing control signal ECS from the timing control circuit 400. The first emission control driver 621 may generate first emission control signals according to the emission timing control signal ECS and sequentially output them to the first emission control lines EML1. The second emission control driver 622 may generate second emission control signals according to the emission timing control signal ECS and sequentially output them to the second emission control lines EML2.

The data driver 800 may include a plurality of data transistors, and the plurality of data transistors may be formed via a semiconductor process and may be formed on the semiconductor substrate. For example, a plurality of data transistors may be implemented as CMOS transistors. It should be understood, however, that the embodiments of the present disclosure are not limited thereto.

The data driver 800 may receive digital video data DATA and a data timing control signal DCS from the timing control circuit 400. The data driver 800 converts the digital video data DATA into analog data voltages according to the data timing control signal DCS and outputs them to the data lines DL. In doing so, the sub-pixels SP1, SP2 and SP3 are selected by the write scan signal from the scan driver 610, and data voltages may be applied to the selected sub-pixels SP1, SP2 and SP3.

The heat dissipation layer 200 may overlap with the display panel 100 in the third direction DR3, which is the thickness direction of the display panel 100. The heat dissipation layer 200 may be located on one surface of the display panel 100, e.g., on the rear surface. The heat dissipation layer 200 serves to release heat generated in the display panel 100. The heat dissipation layer 200 may include a metal layer such as graphite, silver (Ag), copper (Cu) and aluminum (Al) having a high thermal conductivity.

The circuit board 300 may be electrically connected to a plurality of pads in a pad area of the display panel 100 using a conductive adhesive member such as an anisotropic conductive film. The circuit board 300 may be a flexible printed circuit board made of a flexible material, or a flexible film. Although the circuit board 300 is unfolded in the example shown in FIG. 1, the circuit board 300 may be bent. When the circuit board 300 is bent, one end of the circuit board 300 may be located on the rear surface of the display panel 100 and/or the rear surface of the heat dissipation layer 200. The other end of the circuit board 300 may be connected to a plurality of pads in the pad area of the display panel 100 using a conductive adhesive material. One end of the circuit board 300 may be opposite to the other end of the circuit board 300.

The timing control circuit 400 may receive digital video data and timing signals from the outside. The timing control circuit 400 may generate a scan timing control signal SCS, an emission timing control signal ECS, and a data timing control signal DCS for controlling the display panel 100 in response to the timing signals. The timing control circuit 400 may output the scan timing control signal SCS to the scan driver 610 and output the emission timing control signal ECS to the emission driver 620. The timing control circuit 400 may output the digital video data and the data timing control signal DCS to the data driver 800.

A power supply circuit 500 may generate a plurality of panel driving voltages in response to a supply voltage from the outside. For example, the power supply circuit 500 may generate a first supply voltage VSS, a second supply voltage VDD, and a third supply voltage VREF to apply them to the display panel 100. The first supply voltage VSS, the second supply voltage VDD and the third supply voltage VREF will be described in more detail later with reference to FIG. 3.

Each of the timing control circuit 400 and the power supply circuit 500 may be implemented as an integrated circuit (IC) and attached to a surface of the circuit board 300. The scan timing control signal SCS, the emission timing control signal ECS, the digital video data DATA and the data timing control signal DCS from the timing control circuit 400 may be supplied to the display panel 100 through the circuit board 300. The first supply voltage VSS, the second supply voltage VDD and the third supply voltage VREF of the power supply circuit 500 may be supplied to the display panel 100 through the circuit board 300.

Alternatively, each of the timing control circuit 400 and the power supply circuit 500 may be located in the non-display area NDA of the display panel 100, similarly to the scan driver 610, the emission driver 620 and the data driver 800. In this instance, the timing control circuit 400 may include a plurality of timing transistors, and each power supply circuit 500 may include a plurality of power transistors. A plurality of timing transistors and a plurality of power transistors may be formed via a semiconductor process and may be formed on the semiconductor substrate. For example, the plurality of timing transistors and the plurality of power transistors may be formed of CMOS transistors. It should be understood, however, that the embodiments of the present disclosure are not limited thereto. Each of the timing control circuit 400 and the power supply circuit 500 may be located between the data driver 800 and the pad area.

FIG. 3 is an equivalent circuit diagram of a first sub-pixel according to some embodiments of the present disclosure. Although FIG. 3 illustrates various components in a sub-pixel according to some embodiments, embodiments according to the present disclosure are not limited thereto, and according to some embodiments, the sub-pixel may include additional components, or fewer components, without departing from the spirit and scope of embodiments according to the present disclosure.

Referring to FIG. 3, a first sub-pixel SP1 may be connected to a write scan line GWL, an initialization scan line GIL, a bias scan line GBL, a first emission control line EML1, a second emission control line EML2 and a data line DL. In addition, the first sub-pixel SP1 may be connected to a first supply voltage line VSL where the first supply voltage VSS equal to a low-level voltage (e.g., a ground voltage) is applied, a second supply voltage line VDL where the second supply voltage VDD equal to a high-level voltage is applied, and a third supply voltage line VRL where the third supply voltage VREF equal to a third supply voltage (or an initialization voltage) is applied. In other words, the first supply voltage line VSL may be a low-level voltage line, the second supply voltage line VDL may be a high-level voltage line, and the third supply voltage line VRL may be a reference voltage line VRL. The first supply voltage VSS may be lower than the third supply voltage VREF. The second supply voltage VDD may be higher than the third supply voltage VREF.

The first sub-pixel SP1 may include a plurality of transistors T1 to T7, a light-emitting element LE, a first capacitor C1, and a second capacitor C2.

The light-emitting element LE emits light in proportional to a driving current flowing in a channel of the first transistor T1. The amount of the light emitted from the light-emitting element LE may be proportional to the driving current. The light-emitting element LE may be located between the seventh transistor T7 and the first supply voltage line VSL. The first electrode of the light-emitting element LE may be connected to a source electrode of the seventh transistor T7, and the second electrode thereof may be connected to the first supply voltage line VSL. The first electrode of the light-emitting element LE may be an anode electrode, and the second electrode of the light-emitting element LE may be a cathode electrode. The light-emitting element LE may be an organic light-emitting diode including a first electrode, a second electrode, and an organic light-emitting layer located between the first electrode and the second electrode. It should be understood, however, that embodiments according to the present disclosure are not limited thereto. For example, the light-emitting element LE may be an inorganic light-emitting element including a first electrode, a second electrode, and an inorganic semiconductor located between the first electrode and the second electrode. In this instance, the light-emitting element LE may be a micro light-emitting diode.

The first transistor T1 may be a driving transistor for controlling the drain-source current (e.g., driving current) flowing between the drain electrode and the source electrode according to the voltage applied to the gate electrode. The first transistor T1 may include the gate electrode connected to a first node N1, the drain electrode of the first transistor T1 may be connected to a source electrode of a sixth transistor T6, and the source electrode of the first transistor T1 may be connected to a drain electrode of the seventh transistor T7.

The second transistor T2 may be connected between the data line DL and a third node N3. The second transistor T2 may include a gate electrode connected to the write scan line GWL, a drain electrode of the second transistor T2 may be connected to the data line DL, and a source electrode of the second transistor T2 may be connected to the third node N3.

A third transistor T3 may be connected between the first node N1 and the third supply voltage VRL. The third transistor T3 may include a gate electrode connected to the initialization scan line GIL, a drain electrode of the third transistor T3 may be connected to the first node N1, and a source electrode of the third transistor T3 may be connected to the third supply voltage line VRL.

The fourth transistor T4 may be connected between the third node N3 and the second node N2. The fourth transistor T4 may include a gate electrode connected to the initialization scan line GIL, a drain electrode of the fourth transistor T4 may be connected to the third node N3, and a source electrode of the fourth transistor T4 may be connected to the second node N2.

The fifth transistor T5 may be connected between the fourth node N4 and the first supply voltage line VSL. The fifth transistor T5 may include a gate electrode connected to the bias scan line GBL, a drain electrode of the fifth transistor T5 may be connected to the fourth node N4, and a source electrode of the fifth transistor T5 may be connected to the first supply voltage line VSL.

The sixth transistor T6 may be connected between the second supply voltage line VDL and the drain electrode of the first transistor T1. The sixth transistor T6 may include a gate electrode connected to the first emission control line EML1, a drain electrode of the sixth transistor T6 may be connected to the second supply voltage line VDL, and a source electrode of the sixth transistor T6 may be connected to the drain electrode of the first transistor T1.

The seventh transistor T7 may be connected between the second node N2 and the fourth node N4. The seventh transistor T7 may include a gate electrode connected to the second emission control line EML2, a drain electrode of the seventh transistor T7 may be connected to the second node N2, and a source electrode of the seventh transistor T7 may be connected to the fourth node N4.

Each of the above-described first to seventh transistors T1 to T7 may be an n-type metal-oxide-semiconductor field effect transistor (MOSFET).

The first capacitor C1 may be connected between the first node N1 and the third node N3.

The second capacitor C2 may be connected between the third node N3 and the fourth node N4. The capacitance of the second capacitor C2 may be different from the capacitance of the first capacitor C1. For example, the capacitance of the first capacitor C1 may be greater than the capacitance of the second capacitor C2.

Each of the second sub-pixel SP2 and the third sub-pixel SP3 may have the same equivalent circuit as the first sub-pixel SP1 of FIG. 3 described above.

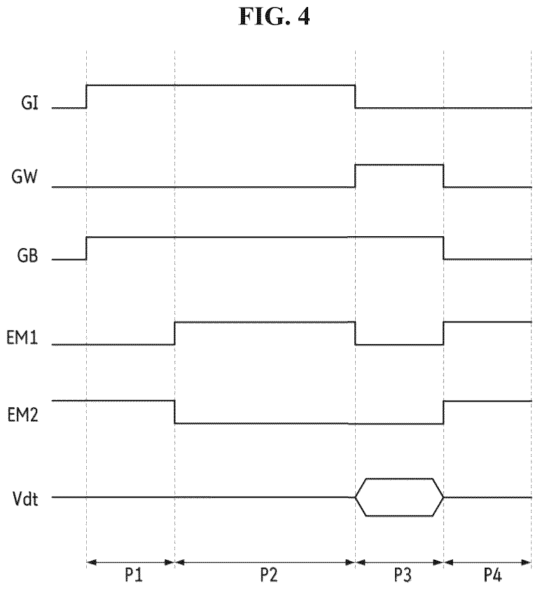

FIG. 4 is a timing diagram of an initialization scan signal GI, a write scan signal GW, a bias scan signal GB, a first emission control signal EM1, a second emission control signal EM2 and a data signal Vdt of FIG. 3.

Referring to FIG. 4, the display device 10 may operate based on an initialization period P1, a threshold voltage detection period P2, a data write period P3, and an emission period P4.

Each of the initialization scan signal GI, the write scan signal GW, the bias scan signal GB, the first emission control signal EM1 and the second emission control signal EM2 may have an active level or a non-active level for each of the above-described periods P1, P2, P3 and P4. The active level of each of the signals GI, GW, GB, EM1 and EM2 may refer to a voltage at the level that can turn on a transistor to which the signal is applied. In other words, the signal at the active level may have a value larger than the threshold voltages of that transistor. For example, when a transistor is an n-type transistor, the active level of the signal applied to the gate electrode of the transistor may mean a high level (e.g., a positive polarity level or a high voltage level).

The non-active level of each of the signals GI, GW, GB, EM1 and EM2 may mean a voltage at the level that can turn off the respective transistors. In other words, the signals at the non-active level may have a value smaller than the threshold voltages of the respective transistors. For example, when a transistor is an n-type transistor, the non-active level of the signal applied to the gate electrode of that transistor may mean a low level (e.g., a negative polarity level or a low voltage level).

Alternatively, for a p-type transistor, the non-active level of a signal applied to the gate electrode of the transistor may refer to a low level (e.g., a negative polarity level or low voltage level), and the non-active level of a signal applied to the gate electrode of the transistor may refer to a high level (e.g., a positive polarity level or a high voltage level).

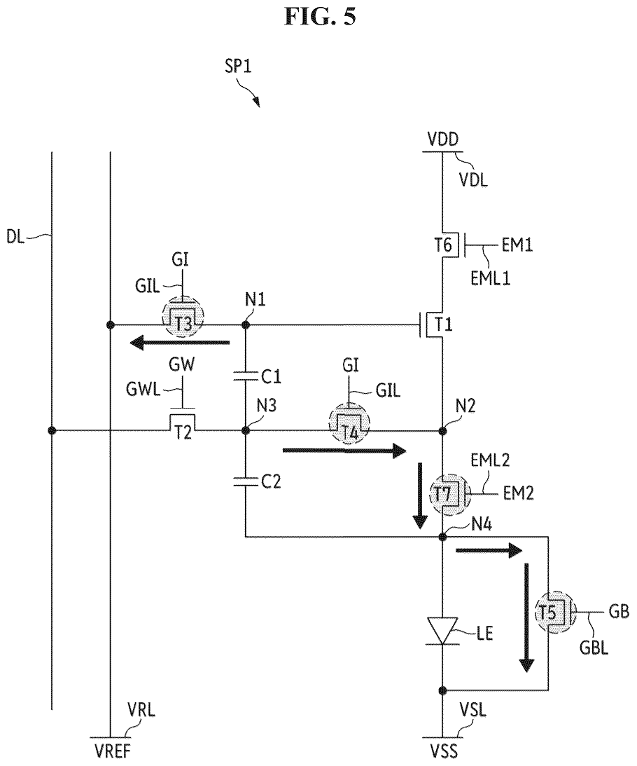

The operations of the display device 10 according to some embodiments of the present disclosure will be described with reference to FIGS. 4 to 8. It should be noted that in FIGS. 5 to 8, the transistors surrounded by the dashed circles are turned on while the other transistors than the transistors surrounded by the dashed circles are turned off. In addition, arrows in FIGS. 5 to 8 indicate current flows.

Initially, referring to FIGS. 4 and 5, the operation of the display device 10 in the initialization period P1 will be described below.

FIG. 5 is a diagram for illustrating the operation of the display device 10 of FIG. 3 in the initialization period P1 of FIG. 4.

As shown in FIG. 4, in the initialization period P1, each of the initialization scan signal GI, the bias scan signal GB and the second emission control signal EM2 may have an active level. On the other hand, each of the write scan signal GW and the first emission control signal EM1 may have the non-active level during the initialization period P1.

The initialization scan signal GI of the active level may be applied to the gate electrode of the third transistor T3 through the initialization scan line GIL and may also be applied to the gate electrode of the fourth transistor T4. Accordingly, each of the third transistor T3 and the fourth transistor T4 may be turned on.

The bias scan signal GB of the active level may be applied to the gate electrode of the fifth transistor T5 through the bias scan line GBL. Accordingly, the fifth transistor T5 may be turned on.

The second emission control signal EM2 of the active level may be applied to the gate electrode of the seventh transistor T7 through the second emission control line EML2. Accordingly, the seventh transistor T7 may be turned on.

The write scan signal GW of the non-active level may be applied to the gate electrode of the second transistor T2 through the write scan line GWL. Accordingly, the second transistor T2 may be turned off.

The first emission control signal EM1 of the non-active level may be applied to the gate electrode of the sixth transistor T6 through the first emission control line EML1. Accordingly, the sixth transistor T6 may be turned off.

As described above, as the third transistor T3 is turned on, the third supply voltage VREF from the third supply voltage line VRL may be applied to the first node N1 through the turned-on third transistor T3. Accordingly, the voltage of the first node N1 may be initialized to the third supply voltage VREF.

As described above, as each of the fourth transistor T4, the seventh transistor T7 and the fifth transistor T5 is turned on, the first supply voltage VSL from the first supply voltage line VSL may be applied to the fourth node N4, the second node N2 and the third node N3 through the turned-on transistors T4, T7 and T5. Accordingly, the voltage of each of the fourth node N4, the second node N2 and the third node N3 may be initialized to the first supply voltage VSL.

As the first node N1, the second node N2, the third node N3 and the fourth node N4 are initialized during the initialization period P1, the voltages of each of the gate electrode of the first transistor T1, the source electrode of the first transistor T1, the two electrodes of the first capacitor C1, the two electrodes of the second capacitor C2, and the first electrode (e.g., the anode electrode) of the light-emitting element LE connected to the nodes N1, N2, N3 and N4 may be initialized.

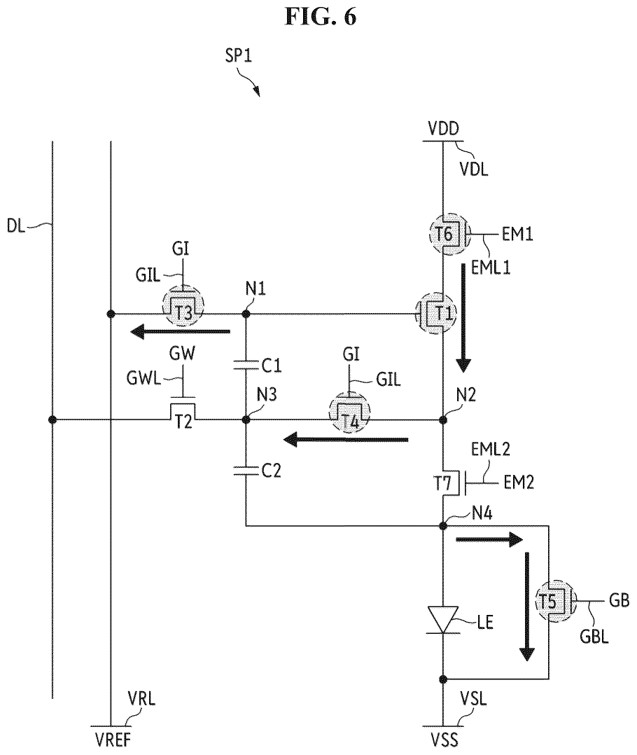

Subsequently, with reference to FIGS. 4 and 6, the operation of the display device 10 in the threshold voltage detection period P2 will be described as follows.

FIG. 6 is a diagram for illustrating the operation of the display device 10 of FIG. 3 in the threshold voltage detection period P2 of FIG. 4.

As shown in FIG. 4, in the threshold voltage detection period P2, each of the initialization scan signal GI, the bias scan signal GB and the first emission control signal EM1 may have the active level. On the other hand, each of the write scan signal GW and the second emission control signal EM2 may have the non-active level during the threshold voltage detection period P2.

The initialization scan signal GI of the active level may be applied to the gate electrode of the third transistor T3 through the initialization scan line GIL and may also be applied to the gate electrode of the fourth transistor T4. Accordingly, each of the third transistor T3 and the fourth transistor T4 may be turned on.

The bias scan signal GB of the active level may be applied to the gate electrode of the fifth transistor T5 through the bias scan line GBL. Accordingly, the fifth transistor T5 may be turned on.

The first emission control signal EM1 of the active level may be applied to the gate electrode of the sixth transistor T6 through the first emission control line EML1. Accordingly, the sixth transistor T6 may be turned on.

The write scan signal GW of the non-active level may be applied to the gate electrode of the second transistor T2 through the write scan line GWL. Accordingly, the second transistor T2 may be turned off.

The second emission control signal EM2 of the non-active level may be applied to the gate electrode of the seventh transistor T7 through the second emission control line EML2. Accordingly, the seventh transistor T7 may be turned off.

As described above, as the third transistor T3 remains turned on, the third supply voltage VREF may be applied to and maintained at the first node N1, and the first transistor T1 may be turned on by the third supply voltage VREF. Then, electric current may flow through the turned-on first transistor T1. For example, electric current may flow from the first supply voltage line VSL to the second node N2 and the third node N3 through the turned-on sixth transistor T6, the turned-on first transistor T1, and the turned-on fourth transistor T4. As the electric current flows into the second node N2 and the third node N3, the voltages of the second node N2 and the third node N3 may gradually increase. The voltages of the second node N2 and the third node N3 gradually increase, and as soon as the voltage difference between the voltage of the first node N1 and the voltage of the second node N2 (e.g., the gate-source voltage of the first transistor T1) reaches the threshold voltage of the first transistor T1, the first transistor T1 is turned off. At this time, the threshold voltage of the first transistor T1 may be stored by the first capacitor C1 and the second capacitor C2. In other words, the threshold voltage of the first transistor T1 may be detected at the moment when the first transistor T1 is turned off. For example, a voltage obtained by subtracting the threshold voltage of the first transistor T1 from the third supply voltage VREF may be stored in the third node N3. In other words, the voltage of the third node N3 may have the value equal to VREF-Vth, where Vth denotes the threshold voltage of the first transistor T1.

In addition, as described above, because the fifth transistor T5 remains turned on, the voltage of the fourth node N4 may be maintained at the first supply voltage VSS.

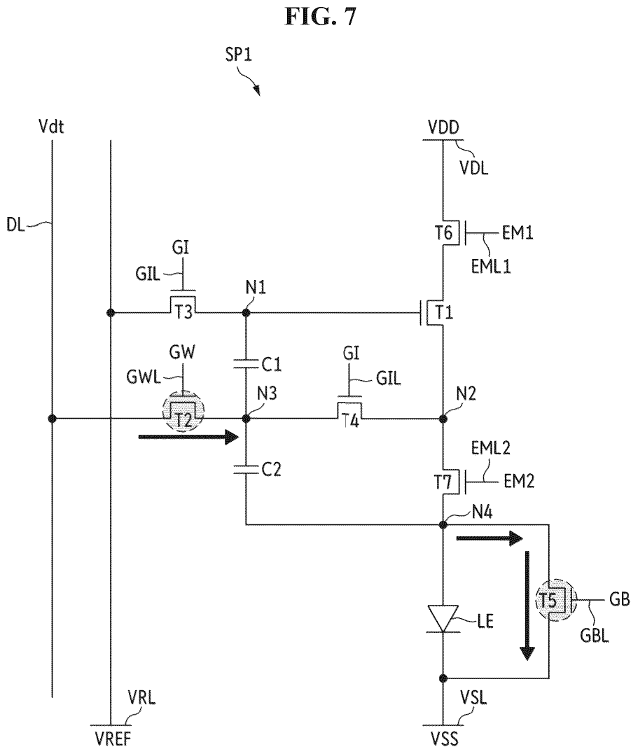

Subsequently, with reference to FIGS. 4 and 7, the operation of the display device 10 in the data write period P3 will be described as follows.

FIG. 7 is a diagram for illustrating the operation of the display device 10 of FIG. 3 in the data write period P3 of FIG. 4.

As shown in FIG. 4, during the data write period P3, each of the write scan signal GW and the bias scan signal GB may have the active level. On the other hand, during the data write period P3, each of the initialization scan signal GI, the first emission control signal EM1 and the second emission control signal EM2 may have the non-active level. Incidentally, in that data write period P3, a data voltage Vdt may be applied to the data line DL. For example, during the data write period P3, the data voltage Vdt associated with the first sub-pixel may be applied to the data line DL.

The write scan signal GW of the active level may be applied to the gate electrode of the second transistor T2 through the write scan line GWL. Accordingly, the second transistor T2 may be turned on.

The bias scan signal GB of the active level may be applied to the gate electrode of the fifth transistor T5 through the bias scan line GBL. Accordingly, the fifth transistor T5 may be turned on.

The initialization scan signal GI of the non-active level may be applied to the gate electrode of the third transistor T3 through the initialization scan line GIL and may also be applied to the gate electrode of the fourth transistor T4. Accordingly, each of the third transistor T3 and the fourth transistor T4 may be turned off.

The first emission control signal EM1 of the non-active level may be applied to the gate electrode of the sixth transistor T6 through the first emission control line EML1. Accordingly, the sixth transistor T6 may be turned off.

The second emission control signal EM2 of the non-active level may be applied to the gate electrode of the seventh transistor T7 through the second emission control line EML2. Accordingly, the seventh transistor T7 may be turned off.

As described above, as the second transistor T2 is turned on, the data voltage Vdt from the data line DL may be applied to the source electrode of the first transistor T1 (e.g., the first node N1) through the turned-on second transistor T2. At this time, the data voltage Vdt and the threshold voltage of the first transistor T1 may be reflected to the first node N1 and the third node N3 depending on the capacitance ratio between the first capacitor C1 and the second capacitor C2. For example, the voltage of the first node N1 may have the value of Vdt+|Vth|, and the voltage of the second node N2 may have the value of Vdt−VREF+|Vth|. Accordingly, the threshold voltage of the first transistor T1 may be reflected in the data voltage Vdt.

In addition, as described above, because the fifth transistor T5 remains turned on, the voltage of the fourth node N4 may be maintained at the first supply voltage VSS.

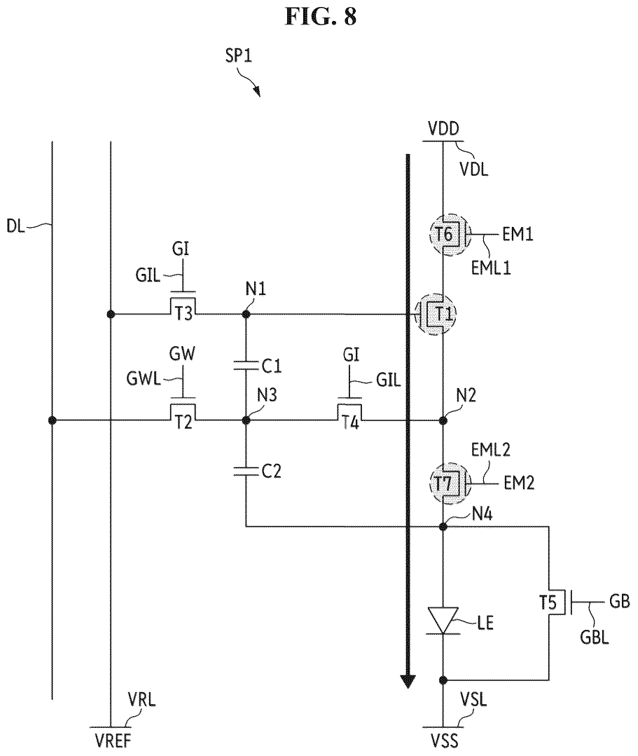

Subsequently, with reference to FIGS. 4 and 8, the operation of the display device 10 in the emission period P4 will be described as follows.

FIG. 8 is a diagram for illustrating the operation of the display device 10 of FIG. 3 in the emission period P4 of FIG. 4.

As shown in FIG. 4, in the emission period P4, each of the first emission control signal EM1 and the second emission control signal EM2 may have the active level. On the other hand, during the emission period P4, each of the initialization scan signal GI, the write scan signal GW and the bias scan signal GB may have the non-active level.

The first emission control signal EM1 of the active level may be applied to the gate electrode of the sixth transistor T6 through the first emission control line EML1. Accordingly, the sixth transistor T6 may be turned on.

The second emission control signal EM2 of the active level may be applied to the gate electrode of the seventh transistor T7 through the second emission control line EML2. Accordingly, the seventh transistor T7 may be turned on.

The initialization scan signal GI of the non-active level may be applied to the gate electrode of the third transistor T3 through the initialization scan line GIL and may also be applied to the gate electrode of the fourth transistor T4. Accordingly, each of the third transistor T3 and the fourth transistor T4 may be turned off.

The write scan signal GW of the non-active level may be applied to the gate electrode of the second transistor T2 through the write scan line GWL. Accordingly, the second transistor T2 may be turned off.

The bias scan signal GB of the non-active level may be applied to the gate electrode of the fifth transistor T5 through the bias scan line GBL. Accordingly, the fifth transistor T5 may be turned off.

The first transistor T1 may be turned on by the voltage of the first node N1. For example, the first transistor T1 may remain turned on by the gate-source voltage held by the first capacitor C1 and the second capacitor C2 (e.g., the gate-source voltage of the first transistor T1). At this time, the voltage of the first node N1 may have the value of Vdt+|Vth|+ΔVa, where ΔVa may denote the amount of voltage change of the fourth node N4. For example, ΔVa may be the voltage difference between the voltage of the fourth node N4 in the data write period P3 and the voltage of the fourth node N4 in the emission period P4. The voltage of the fourth node N4 may have the value of VSS+ΔVa, for example.

As described above, as each of the sixth transistor T6, the first transistor T1 and the seventh transistor T7 is turned on, a driving current may be supplied to the light-emitting element LE through the turned-on sixth transistor T6, the first transistor T1 and the seventh transistor T7. Therefore, the light-emitting element LE may emit light in proportional to the driving current. At this time, the gate-source voltage of the first transistor T1 held by the first capacitor C1 and the second capacitor C2 includes the threshold voltage of the first transistor T1, and thus the magnitude of the driving current flowing to the light-emitting element LE through the turned-on first transistor T1 may be determined based on the data voltage and the threshold voltage of the first transistor T1. Therefore, the driving current supplied to the light-emitting element LE can accurately reflect the magnitude of the data voltage in which the threshold voltage is reflected. As such, as different threshold voltages of the first transistors T1 of the pixels are compensated and the driving current of each of the sub-pixels is determined, it may be possible to relatively reduce the luminance deviations between the sub-pixels according to the deviations of the threshold voltages of the first transistors T1 of the sub-pixels. In this manner, the image quality of the display device 10 can be relatively improved.

According to some embodiments, one side of the second capacitor C2 may be connected to the fourth node N4. Accordingly, the voltage of the fourth node N4 may be compensated through the first capacitor C1 and the second capacitor C2. Accordingly, the voltage fluctuation rate of the fourth node N4 can be relatively reduced, so that the luminance deviations of the light-emitting element LE in adjacent emission periods P4 having a large grayscale difference can be relatively reduced.

According to some embodiments, during the data write period P4, the fourth node N4 is initialized to the first supply voltage VSS provided through the turned-on fifth transistor T5, so that the influence according to the degree of deterioration of the emissive layer of the light-emitting element LE can be eliminated during a process of compensating the threshold voltage in that data write period P4. Therefore, the threshold voltage of the first transistor T1 can be accurately compensated regardless of the degree of deterioration of the emissive layer in the data write period P4.

According to some embodiments, all of the transistors T1, T2, T3, T4, T5, T6 and T7 of the sub-pixels may be n-type metal-oxide-semiconductor field-effect transistors (MOSFETs). Accordingly, the degree of integration of the transistors can be relatively improved.

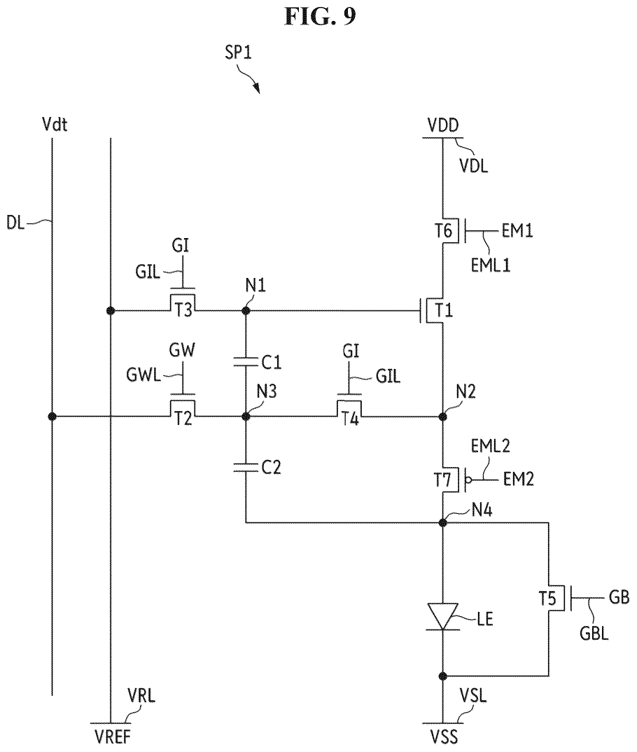

FIG. 9 is an equivalent circuit diagram of a first sub-pixel according to some embodiments of the present disclosure. Although FIG. 9 illustrates various components in a sub-pixel according to some embodiments, embodiments according to the present disclosure are not limited thereto, and according to some embodiments, the sub-pixel may include additional components, or fewer components, without departing from the spirit and scope of embodiments according to the present disclosure.

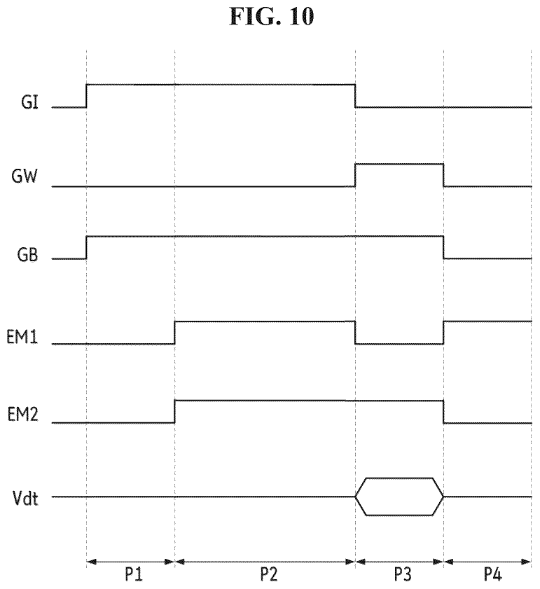

FIG. 10 is a timing diagram of the initialization scan signal GI, the write scan signal GW, the bias scan signal GB, the first emission control signal EM1, the second emission control signal EM2 and the data signal Vdt of FIG. 9.

A first sub-pixel of FIG. 9 is substantially identical to the first sub-pixel of FIG. 3 described above except that a seventh transistor T7 is a p-type MOSFET; and, therefore, the redundant descriptions will be omitted.

As shown in FIG. 9, the seventh transistor T7 may be a p-type MOSFET. Accordingly, as shown in FIG. 10, the second emission control signal EM2 input to the gate electrode of the seventh transistor T7 may be different from the second emission control signal EM2 of FIG. 4 described above. For example, as shown in FIG. 10, the second emission control signal EM2 may have a low level (e.g., a negative level or a low voltage level) as an active level in each of the initialization period P1 and the emission period P4, and a high level (e.g., a positive level or a high voltage level) as an non-active level in each of the threshold voltage detection period P2 and the data write period P3.

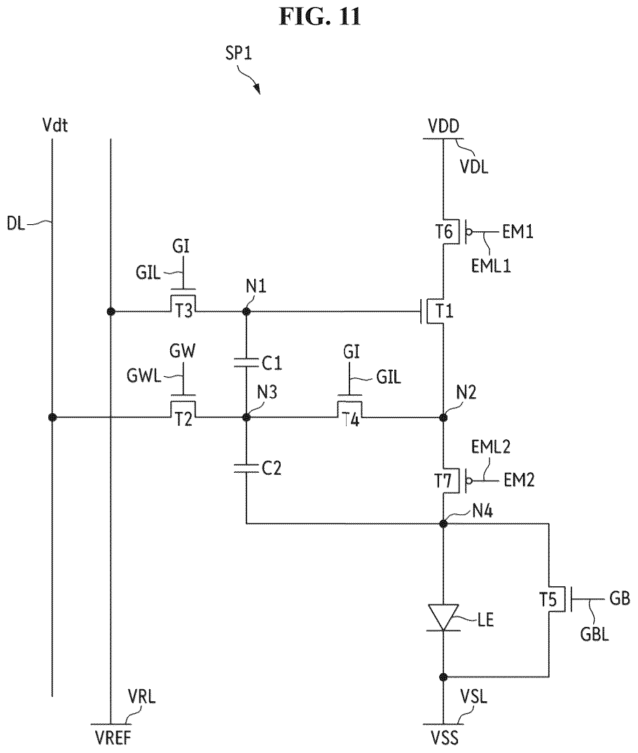

FIG. 11 is an equivalent circuit diagram of a first sub-pixel according to some embodiments of the present disclosure. Although FIG. 11 illustrates various components in a sub-pixel according to some embodiments, embodiments according to the present disclosure are not limited thereto, and according to some embodiments, the sub-pixel may include additional components, or fewer components, without departing from the spirit and scope of embodiments according to the present disclosure.

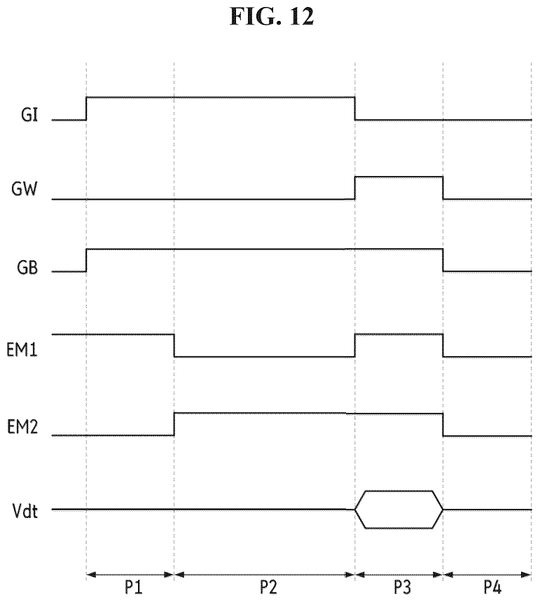

FIG. 12 is a timing diagram of the initialization scan signal GI, the write scan signal GW, the bias scan signal GB, the first emission control signal EM1, the second emission control signal EM2 and the data signal Vdt of FIG. 11.

A first sub-pixel of FIG. 11 is substantially identical to the first sub-pixel of FIG. 3 described above except that a sixth transistor T6 and a seventh transistor T7 are p-type MOSFETs; and, therefore, the redundant descriptions will be omitted.

As shown in FIG. 11, each of the sixth transistor T6 and the seventh transistor T7 may be a p-type MOSFET. Accordingly, as shown in FIG. 12, the first emission control signal EM1 input to the gate electrode of the sixth transistor T6 and the second emission control signal EM2 input to the gate electrode of the seventh transistor T7 may be different from the first emission control signal EM1 and the second emission control signal EM2 of FIG. 4, respectively. For example, as shown in FIG. 12, the first emission control signal EM1 may have a low level (e.g., a negative level or a low voltage level) as the active level in each of the initialization period P1 and the data write period P3, and a high level (e.g., a positive level or a high voltage level) as the non-active level in each of the threshold voltage detection period P2 and the emission period P4. In addition, the second emission control signal EM2 may have a low level (e.g., a negative level or a low voltage level) as the active level in each of the initialization period P1 and the emission period P4, and a high level (e.g., a positive level or a high voltage level) as the non-active level in each of the threshold voltage detection period P2 and the data write period P3.

The display device 10 according to some embodiments may be applied to a variety of electronic devices. An electronic device according to some embodiments includes the display device 10 described above, and may further include a module or device having additional features in addition to the display device 10.

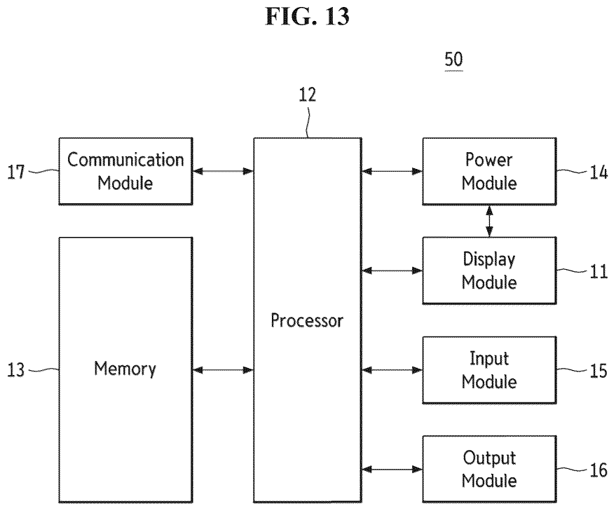

FIG. 13 is a block diagram of an electronic device according to some embodiments of the present disclosure.

Referring to FIG. 13, an electronic device 50 according to some embodiments of the present disclosure may include a display module 11, a processor 12, a memory 13, and a power module 14. The electronic device 50 may further include an input module 14, a non-image output module 15, and/or a communication module 16.

The electronic device 50 may output various information in the form of images through the display module 11. When the processor 12 executes an application stored in the memory 13, image information provided by the application may be provided to the user through the display module 11. The power module 14 may include a power supply module such as a power adapter and a battery device, and a power conversion module that converts the power supplied by the power supply module to generate power required for the operation of the electronic device 50. The input module 14 may provide input information to the processor 12 and/or the display module 11. The non-image output module 15 may receive information other than images from the processor 12, such as sound, haptic and light information, and provide it to the user. The communication module 16 is responsible for transmitting and receiving information between the electronic device 50 and an external device, and may include a receiving unit and a transmitting unit.

At least one of the elements of the electronic device 50 described above may be included in the display devices according to the embodiments described above. In addition, some of the individual modules functioning as a single module may be included in the display device while some others may be provided separately from the display device. For example, the display device may include the display module 11, and the processor 12, the memory 13 and the power module 14 may be implemented as other devices inside the electronic device 50 instead of the display device.

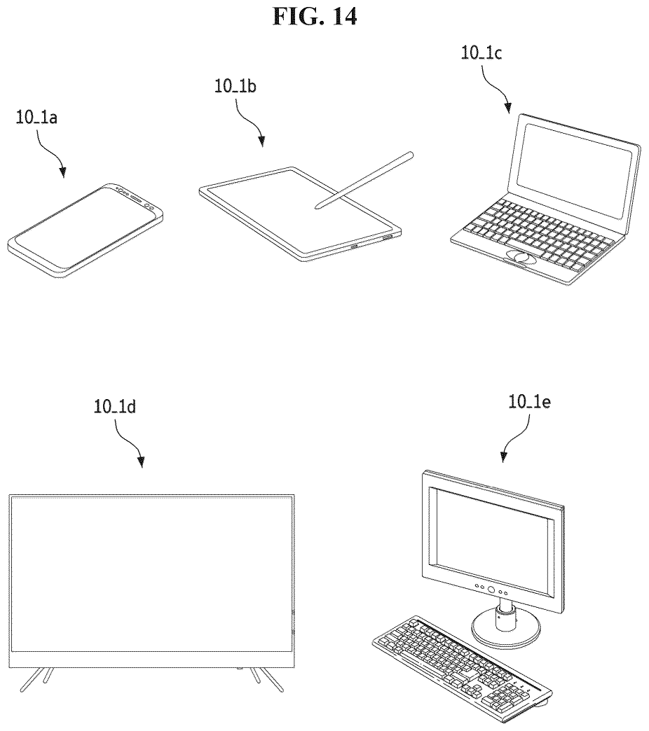

FIGS. 14, 15 and 16 are views showing electronic devices according to a variety of embodiments of the present disclosure. FIGS. 14 to 16 show examples of a variety of electronic devices employing the display devices 10 according to the embodiments.

FIG. 14 shows a smartphone 10_1a, a tablet PC 10_1b, a laptop computer 10_1c, a TV 10_1d, and a desktop monitor 10_1e as examples of the electronic devices.

The smartphone 10_1a may include an input module such as a touch sensor and a communication module in addition to a display module 11. The smartphone 10_1a may process information received through the communication module or other input modules and display the information through the display module of the display device.

The tablet PCs 10_1b, the laptop computer 10_1c, the TV 10_1d and the desktop monitor 10_1e may include display modules and input modules similar to the smartphone 10_1a, and may further include communication modules as desired.

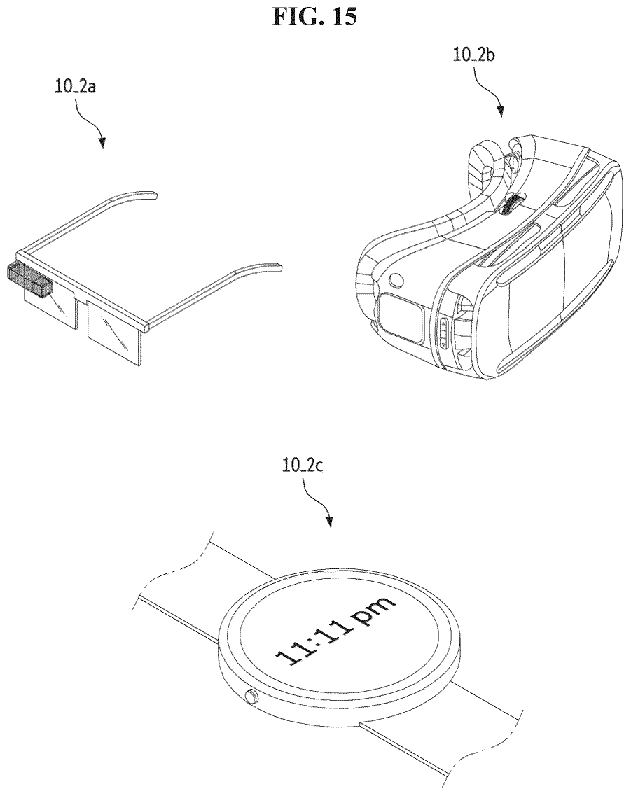

FIG. 15 shows examples of a wearable electronic device employing an electronic device including a display module. The wearable electronic devices may be smart glasses 10_2a, a head-mounted display 10_2b, a smart watch 10_2c, etc.

The smart glasses 10_2a and the head-mounted display 10_2b may include a display module that outputs display images, and a reflector that reflects the output display images and provides it to the user's eyes, thereby providing the user with images of virtual reality or augmented reality on the screen.

The smart watch 10_2c includes a biometric sensor as an input device, and may provide the user with biometric information recognized by the biometric sensor through the display module.

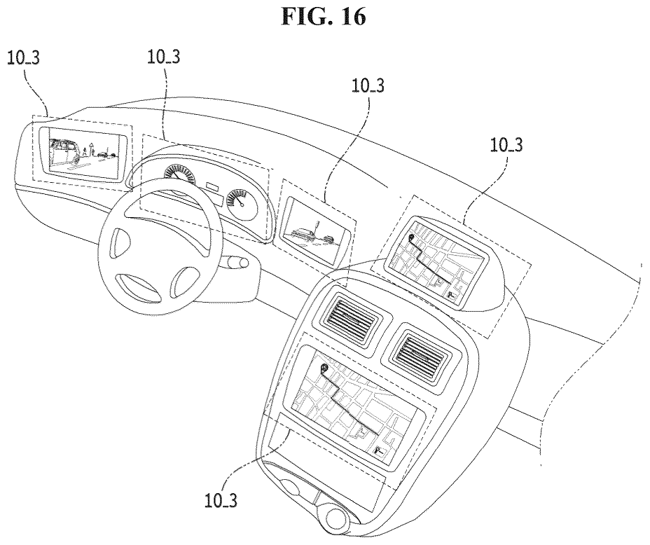

FIG. 16 shows an example of an electronic device including a display module applied to a vehicle. For example, an electronic device 10_3 may be applied to the instrument cluster, the center fascia, etc., of a vehicle, or may be applied to a center information display (CID) located at or within the dashboard of a vehicle, or may be used as a room mirror display on the behalf of the side mirrors of a vehicle.

In concluding the detailed description, those skilled in the art will appreciate that many variations and modifications can be made to the disclosed embodiments without substantially departing from the principles of the present invention. Therefore, the disclosed embodiments of the invention are used in a generic and descriptive sense only and not for purposes of limitation.

What is claimed is:

1. A display device comprising:
a light-emitting element connected between a first supply voltage line and a second supply voltage line;
a first transistor connected between the light-emitting element and the second supply voltage line, and comprising a gate electrode connected to a first node and a source electrode connected to a second node;
a second transistor connected between a data line and a third node;
a third transistor connected between the first node and a third supply voltage line;
a fourth transistor connected between the third node and the second node;
a first capacitor connected between the first node and the third node; and
a second capacitor connected between the third node and a first electrode of the light-emitting element.

2. The display device of claim 1, wherein a capacitance of the first capacitor is greater than a capacitance of the second capacitor.

3. The display device of claim 1, further comprising:
a fifth transistor connected between the first electrode of the light-emitting element and the first supply voltage line;
a sixth transistor connected between the second supply voltage line and a drain electrode of the first transistor; and
a seventh transistor connected between the second node and the first electrode of the light-emitting element.

4. The display device of claim 3, further comprising:
a write scan line connected to a gate electrode of the second transistor;
an initialization scan line connected to each of a gate electrode of the third transistor and a gate electrode of the fourth transistor;
a bias scan line connected to a gate electrode of the fifth transistor;
a first emission control line connected to a gate electrode of the sixth transistor; and
a second emission control line connected to a gate electrode of the seventh transistor.

5. The display device of claim 4, wherein a write scan signal is applied to the write scan line,
wherein the initialization scan line is configured to receive an initialization scan signal,
wherein the bias scan line is configured to receive a bias scan signal,
wherein the first emission control line is configured to receive a first emission control signal,
wherein the second emission control line is configured to receive a second emission control signal,
wherein the data line is configured to receive a data voltage,
wherein the first supply voltage line is configured to receive a first supply voltage,
wherein the second supply voltage line is configured to receive a second supply voltage, and
wherein the third supply voltage line is configured to receive a third supply voltage.

6. The display device of claim 5, wherein each of the initialization scan signal, the bias scan signal and the second emission control signal has an active level during an initialization period.

7. The display device of claim 6, wherein each of the write scan signal and the first emission control signal has a non-active level during the initialization period.

8. The display device of claim 6, wherein each of the initialization scan signal, the bias scan signal and the first emission control signal has the active level in a threshold voltage detection period after the initialization period.

9. The display device of claim 8, wherein each of the write scan signal and the second emission control signal has a non-active level during the threshold voltage detection period.

10. The display device of claim 8, wherein each of the write scan signal and the bias scan signal has the active level during a data write period after the threshold voltage detection period, and
wherein the data voltage is applied to the data line during the data write period.

11. The display device of claim 10, wherein each of the initialization scan signal, the first emission control signal and the second emission control signal has a non-active level during the data write period.

12. The display device of claim 10, wherein each of the first emission control signal and the second emission control signal has the active level during an emission period after the data write period.

13. The display device of claim 12, wherein each of the initialization scan signal, the write scan signal and the bias scan signal has a non-active level during the emission period.

14. The display device of claim 3, wherein each of the first to seventh transistors is an n-type MOSFET.

15. The display device of claim 3, wherein each of the first to sixth transistors is an n-type MOSFET, while the seventh transistor is a p-type MOSFET.

16. The display device of claim 3, wherein each of the first to fifth transistors is an n-type MOSFET, while each of the sixth and seventh transistors is a p-type MOSFET.

17. An electronic device comprising:
a display device including a display screen, wherein the display device comprises: a light-emitting element connected between a first supply voltage line and a second supply voltage line;
a first transistor connected between the light-emitting element and the second supply voltage line, and comprising a gate electrode connected to a first node and a source electrode connected to a second node;
a second transistor connected between a data line and a third node;
a third transistor connected between the first node and a third supply voltage line;
a fourth transistor connected between the third node and the second node;
a first capacitor connected between the first node and the third node; and
a second capacitor connected between the third node and a first electrode of the light-emitting element.

18. The electronic device of claim 17, wherein a capacitance of the first capacitor is greater than a capacitance of the second capacitor.

19. The electronic device of claim 17, further comprising:
a fifth transistor connected between the first electrode of the light-emitting element and the first supply voltage line;
a sixth transistor connected between the second supply voltage line and a drain electrode of the first transistor; and
a seventh transistor connected between the second node and the first electrode of the light-emitting element.

20. The electronic device of claim 17, wherein the electronic device is one of a smartphone, a tablet PC, a laptop computer, a TV, a desktop monitor, smart glasses, a smart watch, a head-mounted display, or a display for vehicles.
